(19) United States
(12) Patent Application Publication
(10) Pub. No.: US 2011/0232339 A1
(43) Pub. Date: Sep. 29, 2011

(54) Rod Locker

(76) Inventors: Nicholas Norman, Fortson, GA (US); John Rodgers, Hamilton, GA (US)

(21) Appl. No.: 13/052,268

(22) Filed: Mar. 21, 2011

Related U.S. Application Data
(60) Provisional application No. 61/316,957, filed on Mar. 24, 2010.

(51) Int. Cl. E05B 73/00; B65D 55/02

(52) U.S. Cl. 70/58; 70/159

(57) ABSTRACT

A portable lock box for enclosing and organizing a plurality of fishing rods with securement means to a base structure. A rectangular box is disclosed with a lockable, hinged roof and cut-outs that accommodate fishing rod penetrations on both lengthwise sides of the box. The box provides a secure container for transporting, protecting and housing a series of fishing rods. Securement means along the bottom of the box are accessible from the box interior and provide mounting points for the assembly to a base structure, preventing theft or movement during transportation. Fishing reels are housed within the internal cavity of the box to prevent theft and to protect them from external damage.

### CROSS REFERENCE TO RELATED APPLICATION

This application claims the benefit of U.S. Provisional Application No. 61/316,957 filed on Mar. 24, 2010, entitled “Rod Locker”

### BACKGROUND OF THE INVENTION

1. Field of the Invention

The present invention relates generally to lock boxes. More specifically, the present invention pertains to secure containment of fishing equipment for storage, anti-theft and transportation purposes.

2. Description of the Prior Art

Transporting fishing rods within a vehicle or in the bed of a pickup truck can be hazardous for the equipment and cause several problems. If a plurality of rods are carried, they can be difficult to organize and can easily tangle with one another. Damage to the rods and associated reels is also a reality, as the rods can move within the vehicle responding to changes in momentum. Impact with other structures or complete ejection of the rod from the vehicle is possible, resulting in a loss of equipment and considerable cost burden on the user. Organizing and containing one or a plurality of fishing rods, particularly in transit, is a common problem for many fishermen.

Theft is also a common concern, as expensive equipment is often left unguarded within the bed of a truck or on a vehicle when the user leaves an area. Thieves find these unsecured items an easy target. Rod organizers that do not include a mounting ability to a structure within the vehicle may also be prone to theft, as the entire assembly can be lifted and carted away just as easily as a series of unorganized rods. Exposed reels that are not enclosed in a secure container are also prone to theft, as the reel can easily be removed from the rod, which can be a very expensive piece of equipment to replace. A solution to these common problems is required, one that incorporates a fishing rod organizer with a lock box, and one that can be secured to a larger structure.

Several devices have been suggested in the art for securing fishing rods and associated reels. U.S. Pat. No. 7,322,149 to Quintero describes a fishing rod organizer and container comprising two mateable halves that contain each rod's reel internal to the container and allow the rods to penetrate through cut-outs in an upper and lower section of each half. While this device is useful for organizing a series of rods and sheltering each rod's reel, there are no means described for securing the container to a larger structure, or a locking mechanism that would prevent one from stealing the rods out of the container.

U.S. Pat. No. 7,219,464 to Kujawa describes a locking storage system for fishing rods with a retention base. The retention base provides an insertion point for a plurality of fishing rod collars, with a sliding lock plate securing the assembly together. A pad lock or combination lock is used to secure the device and prevent theft. This device is very useful for horizontally stacking a series of fishing rods and locking them in place. However, the design does not provide any protection for the reels, which are exposed to the elements and possible theft. The reels can be damaged due to exposure, rust or contamination from other external debris sources.

U.S. Pat. No. 5,435,473 to Larkum describes another device for horizontally stacking a series of fishing rods. In this device, a plurality of vertical tubes is provided that accept the handle end of a fishing rod. A horizontal restraining bar stretches across each tube, and locks the fishing rods and the device together. A pad lock or combination lock is used to lock the restraining bar in place. The base of the device provides mounting points for attachment to a larger structure. Like the patent to Kujawa, this device only locks the rods in place and provides no protection for the reels.

U.S. Pat. No. 4,523,704 to Washington provides a fishing rod holder that is specifically suited for transport in a vehicle or by hand. A series of rods are housed in a carrier that encloses the reel of each rod. A hand portion and gutter mounts provide locations for transporting the device by hand or by car, respectively. While this device protects the reels of each rod and provides an organizing means for a series of rods, this device does not provide permanent attachment points for a larger structure to prevent theft.

A solution is required that solves the common drawbacks present in the art. Specifically, a fishing rod locker is required that provides containment of several fishing rods with an internal chamber for each reel to prevent damage, and one that provides mounting points to a larger structure to prevent theft. A locking mechanism for the internal chamber is also required. The following disclosure therefore remedies the shortcomings in the prior art by providing a device that meets these needs.

### SUMMARY OF THE INVENTION

In view of the foregoing disadvantages inherent in the known types of fishing rod lock boxes now present in the prior art, the present invention provides a new fishing rod lock box wherein the same can be utilized for providing convenience for the user when securing or transporting fishing equipment.

It is therefore an object of the present invention to provide a lockable fishing rod box that houses and protects a plurality of fishing rods and reels.

Another object of the present invention is to provide a fishing rod lock box that is mountable to a larger structure, such as a vehicle, a fishing dock or a boat.

Yet another object of the present invention is to provide a fishing rod organizer and lock box that is easily transported in a vehicle or on a boat.

Other objects, features and advantages of the present invention will become apparent from the following detailed description taken in conjunction with the accompanying drawings.

### BRIEF DESCRIPTIONS OF THE DRAWINGS

FIG. 1 shows a front perspective view of the first embodiment of the rod lock box, including a single fishing rod and reel.

FIG. 2 shows a rear perspective view of the first embodiment of the rod lock box, including a single fishing rod and reel.

FIG. 3 shows a front perspective view of the second embodiment of the rod lock box, including a single fishing rod and reel.

FIG. 4 shows a rear perspective view of the second embodiment of the rod lock box, including a single fishing rod and reel.

### DETAILED DESCRIPTION OF THE INVENTION

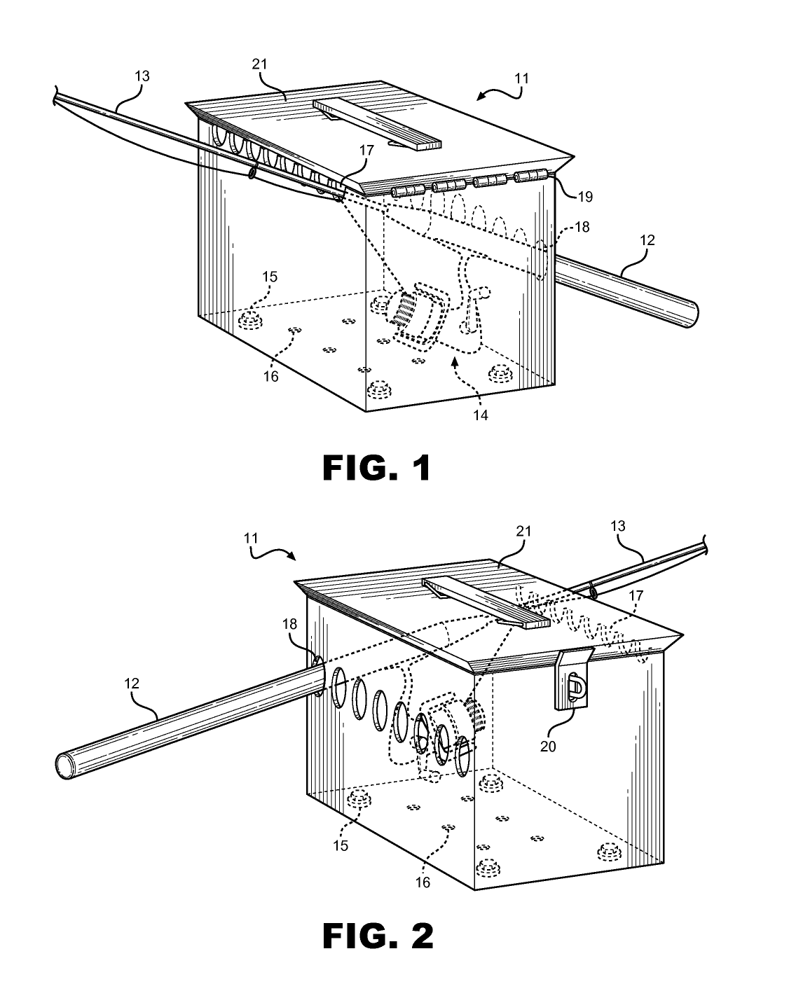

Referring now to FIG. 1, there is shown a front perspective view of the first embodiment of the rock lock box 11. A plurality of handle cutouts 18 and rod cutouts 17 line each side of the box 11 and allow penetration of the rod and handle of a fishing rod. The fishing rod handle 12 is slotted into a first cutout 18 and the rod shaft is rested against an opposing cutout 17 on the opposite side of the box. The cutouts may be circular, oval or any shape suitable for accepting the handle of a fishing rod. The reel 14 is housed inside the cavity of the box 11 and prevented from external contact or tampering. A hinged 19 lid allows the fishing reel to be enclosed within the cavity of the box. A series of structural mounts 15 internal to the box 11 allow the box to be secured to a larger structure for security and stability. Drainage holes 16 line the base of the box 11 to permit moisture and water to leak out of the box after the fishing rod has been used, or after the box has been exposed to rain.

Referring now to FIG. 2, there is shown a rear perspective view of the first embodiment of the rod lock box 11. When the lid 21 of the box is open, a fishing rod handle 12 is placed through a handle cutout 18 while the rod shaft 13 is laid against the rod cutouts 17. The lid 21 is then closed with the reel 14 internal to the box 11. A pad lock latch 20 is used to lock the lid 21 against the box 11 to prevent unauthorized entry. Again, a plurality of drainage holes 16 and mounting points 15 are provided along the base of the box 11.

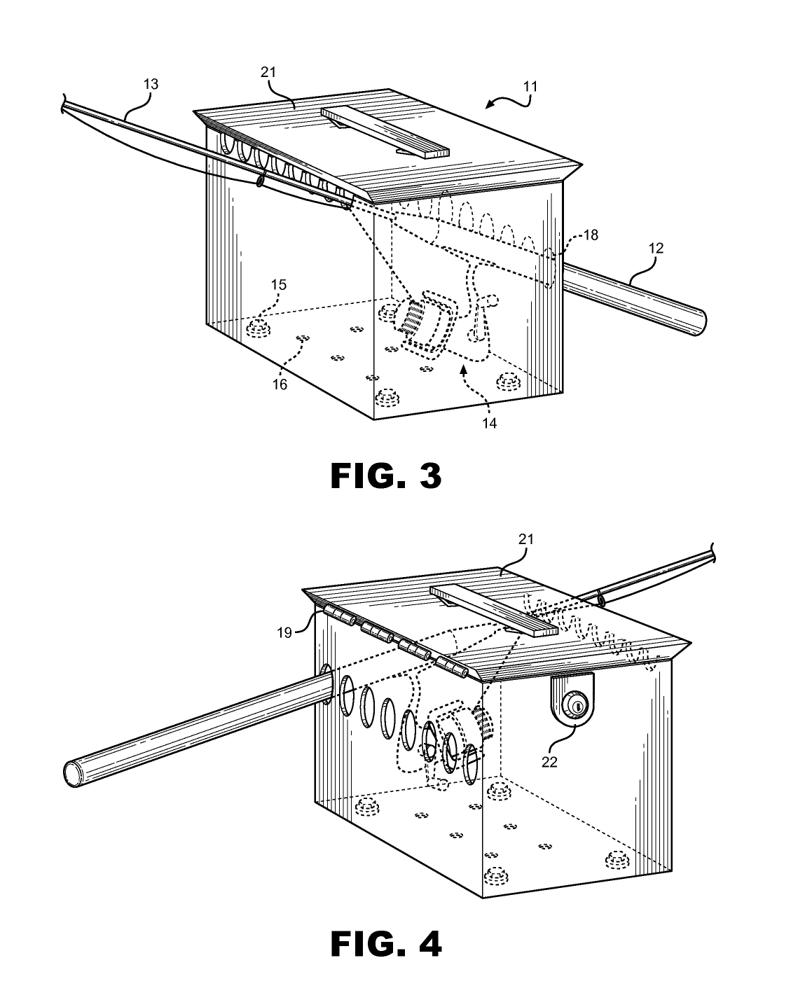

Referring now to FIG. 3, there is shown a front perspective view of the second embodiment of the rod lock box 11. In this embodiment, the lid 21 is hinged 19 along the long side of the box 11, as opposed to the short side. This provides an alternative configuration for opening the box 11 and arranging the fishing rods.

Referring now to FIG. 4, there is shown a rear perspective view of the second embodiment of the rock lock box 11. Along with a hinge 19 on the long side of the box 11, a key entry lock 22 is provided to secure the lid 21 to the box 11. In both FIG. 3 and FIG. 4, the fishing rod shafts and handles are positioned within the box cutouts as they are in the first embodiment.

In use an individual uses the device to store, transport, and protect a plurality of fishing rods and reels. The device allows a user the ability to secure the box to a base structure using the four mounting locations. These locations are holes in the base that allow a threaded bolt or lock bolt to be placed through the base to secure the entire assembly to a larger structure. The mounting structure can be a boat or motor vehicle, particularly the bed of a pickup truck, or it can be a stationary structure such as a building, fishing dock or storage facility for fishing equipment. The mounting points allow accessibility to the bolts only from in the interior cavity of the box, which can be locked to prevent unauthorized access. Therefore, the box may be rigidly mounted to prevent theft of the assembly or its contents.

The box itself may be constructed of any material that prevents easy access to its interior when locked. This may include metallic material such as aluminum or steel, or heavy duty plastic, similar to a tool box or other similar lock box. The number of fishing rods stored within the box is dependent on the size of the box and the number of cutouts provided thereon. The size and number of rods can be any number suitable for the user, including a very large box that holds a number of fishing rods to a smaller box that only houses a few rods.

The lock mechanism may be any suitable device to keep the lid and body of the box mated, and prevent unauthorized access. The two embodiments shown in the figures include a clasp and hook mechanism for an external pad lock, as well as a turnkey locking device.

Drainage holes along the base of the box and the large cutouts along the sides that accommodate the fishing rods allow moisture and fluid to escape the box, preventing corrosion and rust of the interior equipment. It is common for fishing rods to become wet after use. Therefore drainage and proper venting is required to prevent the interior of the device from trapping moisture, which can cause serious mechanical problems for the reels or damage to the rods if left for long periods of time.

The handle along the lid of the box allows the user to transport the assembly by hand, with or without a series of fishing rods. Combined, these elements provide a new and unique fishing rod storage and transport device for the convenience of the user. The box provides a secure location to house a series of fishing rods, and a case that organize and contain server rods and reels simultaneously.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fishing rod lock box for storing and transporting a plurality of fishing rods, comprising:
a box with a first and second long side, a lid and a base;
a plurality of fishing rod handle cutouts along said first long side, and a plurality of fishing rod shaft cutouts along said second long side;
said lid is hinged from and lockably engageable to said box;
a plurality of mount locations line said base for mounting said box to a larger structure.

2) A device as described in claim 1, wherein said base comprises a plurality of drainage holes.

3) A device as described in claim 1, wherein said lid is hinged along said first long side of said box.

4) A device as described in claim 1, wherein said lid is hinged along a short side of said box.

5) A device as described in claim 1, wherein said lockable engagement comprises a clasp and hook device for an external pad lock or combination lock.

6) A device as described in claim 1, wherein said lockable engagement comprises a keyhole lock for locking and releasing said lid.

7) A device as described in claim 1, wherein a carrying handle attaches to said lid.

8) A fishing rod lock box for storing and transporting a plurality of fishing rods, comprising:
a box with a first and second long side, a lid and a base;
a plurality of fishing rod handle cutouts along said first long side, and a plurality of fishing rod shaft cutouts along said second long side;
said lid is hinged from and lockably engageable to said box;
a plurality of mount locations line said base for mounting said box to a larger structure;
said base comprises a plurality of drainage holes;
a carrying handle attaches to said lid.

9) A device as described in claim 8, wherein said lid is hinged along said first long side of said box.

10) A device as described in claim 8, wherein said lid is hinged along a short side of said box.

11) A device as described in claim 8, wherein said lockable engagement comprises a clasp and hook device for an external pad lock or combination lock.

12) A device as described in claim 8, wherein said lockable engagement comprises a keyhole lock for locking and releasing said lid.
